(19) United States
(12) Patent Application Publication
(10) Pub. No.: US 2024/0066614 A1
(43) Pub. Date: Feb. 29, 2024

(54) MILLING TOOL, CUTTER CARRIER AND TOOL HEAD

(71) Applicant: Urma AG Werkzeugfabrik, Rupperswil (CH)

(72) Inventors: Gilbert Zumsteg, Rupperswil (CH); Daniel Berger, Rupperswil (CH)

(21) Appl. No.: 18/454,872

(22) Filed: Aug. 24, 2023

(30) Foreign Application Priority Data
Aug. 26, 2022 (CH) 001003/2022

(51) Int. Cl. B23C 5/20; B23C 5/28

(52) U.S. Cl. CPC B23C 5/20; B23C 5/28

(57) ABSTRACT

A milling tool includes a tool head and an exchangeable cutter carrier. The tool head can be coupled to a tool holder, and the cutter carrier includes a plurality of cutters distributed around its circumference, each having a front facing face cutter and a peripheral cutter extending at an angle thereto. In this case, the cutter carrier, including the cutters, has a thickness of at most ten mm, in particular at most six mm, for a diameter of at least fifty mm.

### BACKGROUND OF THE INVENTION

### Field of the Invention

The invention relates to the field of cutting tools. It relates to a milling tool, in particular for face milling, and a cutter carrier and a tool head.

### Description of Related Art

Milling tools, in particular for face milling, are known from, for example, WO 2018/224547 A1 or DE 10 2017 112374 A1, US 2002/0106251 A1, EP 2484471 A1 and DE 102005031988 A1.

WO 2021/060271 A1 shows a milling head with an exchangeable cutting plate. Coolant is fed into chip spaces from the outside through openings on a base body.

EP 3 782 751 A1 shows a side milling cutter with a flat plate with inserted cutters. The cutters are not designed for heavy loads in the axial direction.

CN 108 213 535 B shows a flat cutter carrier with screwed-on cutters and integrated, internal cooling channels. The cutters are not designed for heavy loads in the axial direction.

### SUMMARY OF THE INVENTION

The object of the invention is to create a milling tool and a cutter carrier and a tool head which can be manufactured inexpensively and have a high changeover accuracy and/or require little effort when replacing a worn cutter carrier, in particular without having to readjust the axial and radial runout of the milling tool on the machine.

The milling tool includes a tool head and an exchangeable cutter carrier. The tool head is configured to be coupled to a tool holder, and the cutter carrier includes a plurality of cutters distributed around its periphery, each cutter includes a front facing face cutter and a peripheral cutter extending at an angle thereto. The cutter carrier, including the cutters, has, for a diameter of at least fifty mm, in particular at least sixty mm, in particular at least ninety mm, a thickness of at most ten mm, in particular at most six mm.

Due to the low thickness, a comparatively low volume and thus a reduced quantity of material is required for production.

In embodiments, the diameter of the cutter carrier is a maximum of two hundred mm, in particular a maximum of one hundred and fifty mm.

In embodiments, the tool head includes a coolant distribution plate on a frontal end face, and the coolant distribution plate includes coolant channels in order to conduct coolant flowing in the axial direction in radial directions to the cutter carrier. In particular, the coolant channels are located internally in the coolant distribution plate.

This makes it possible to supply the cutter carriers with coolant. Internal coolant channels can be created using additive manufacturing techniques, and the base body of the tool head, on the other hand, using conventional techniques.

In embodiments, the coolant distribution plate has a thickness of at most ten mm, in particular at most six mm. This means that this part, which is comparatively complex to manufacture, has a small volume, which shortens the manufacturing time, particularly in an additive manufacturing process. The coolant distribution plate can have a rotationally cylindrical shape.

In embodiments, the coolant distribution plate defines a coolant distribution space that directs coolant flowing in the axial direction to the blade carrier in radial directions through outlet openings. This allows for a simple construction of the coolant distribution plate.

In embodiments, the coolant distribution plate is constructed in several parts, in particular in two parts, wherein at least two parts are placed against each other, with intermediate spaces remaining between the two parts, the intermediate spaces forming the coolant channels. An outer part, facing away from the base body, can be made of metal, in particular aluminium. An inner part, facing the base body, can be made of plastic. This enables a cost-effective construction of the coolant distribution plate.

In embodiments, the cutter carrier includes coolant grooves on an end face, in particular on a frontal end face, for guiding coolant towards the cutters, wherein the coolant grooves run from an inner side of the cutter carrier, as seen in the radial direction, to an outer side of the cutter carrier, and outlet openings of the coolant channels of the coolant distribution plate are aligned with the coolant grooves.

In other words, in each case a coolant channel is aligned with an associated coolant groove. This makes it possible to introduce coolant from the coolant channels into the coolant grooves and thereby guiding coolant to the cutters.

In embodiments, the coolant channels are directed at the cutters. That is, a longitudinal axis of each coolant channel is directed toward an associated cutter. Thereby, a flow of coolant is directed through the coolant channel onto to the cutter.

In embodiments, the following is the case:
side walls of the coolant grooves are aligned with side walls of the coolant channels and the outlet openings, respectively, or
side walls of the coolant channels and the outlet openings respectively define a cross-sectional area that is included in a cross-sectional area defined by the side walls of the coolant grooves.

This can mean that in areas where side walls of the coolant grooves are present, a cross-sectional shape of the outlet openings of the coolant channels coincides with a cross-sectional shape of the coolant grooves. The cross-sectional areas are to be understood in a projection along the direction of flow of the fluid.

This has the effect that coolant flowing through the coolant channels does not collide with part of the blade carrier when passing into the coolant grooves. This would lead to deflection and turbulence of the coolant.

In embodiments, the milling tool includes a central mounting screw for fastening the tool head to a tool holder, and at least three, in particular exactly four adjusting screws arranged around the mounting screw, for exerting in each case a force in a direction parallel to the axis of rotation of the milling tool, for adjusting an alignment of the axis of rotation.

This makes it possible to perform fine adjustment of the axial direction of the milling tool with respect to a machine spindle to which the tool holder is coupled, and thus also of the axial runout of the milling tool. In the event of four adjusting screws being present, each of which is opposite the other in pairs with respect to the mounting screw, the axis direction can be adjusted independently in two directions.

In embodiments, the milling tool includes a centering ring formed on the base body and projecting in the axial direction for centering a cutter carrier placed on the base body, in particular by the centering ring being formed on a radial outer surface as an outer cone, and by the cutter carrier being formed on a corresponding inner surface as an inner cone.

This makes it possible to center the position of the cutter carrier on the tool head. In embodiments, the coolant distribution plate is arranged at least to a part of its extension in axial direction within the centering ring. This allows for a short design of the milling tool.

In embodiments, the milling tool includes grooves which are arranged along a circumference of the basic body and, starting from chip spaces between the cutters or teeth of the cutter carrier, run backwards in the axial direction and, in the process, run in a helically curved manner, having a pitch which increases with increasing distance from the cutter carrier, and, in particular, an initial pitch of the grooves being between thirty and sixty degrees, in particular between forty and fifty degrees.

Thus, in particular due to the increasing pitch of the grooves, the base body forms in the region of the circumferential grooves an axial pump or an axial compressor which conveys cooling liquid, optionally with chips, in the axial direction to the rear. The pitch of the grooves is defined with respect to a surface normal to the tool axis. Thus, a pitch of zero degrees is parallel to the surface, and a pitch of 90 degrees is parallel to the tool axis.

The cutter carrier is provided for a milling tool as described above, wherein the cutter carrier includes a plurality of cutters distributed around its circumference, each cutter including a front facing face cutter and a peripheral cutter extending at an angle thereto. The cutter carrier, including the cutting edges, for a diameter of at least fifty mm has a thickness of at most ten mm, in particular at most six mm.

In embodiments, the cutter carrier is made of hard metal, ceramic or mixed forms thereof.

Mixed forms of metal and ceramic are also referred to as metal-ceramic or cermet or metal-bonded ceramic. This makes it possible to manufacture the tool head from a comparatively inexpensive and lightweight material yet providing an overall rigid milling tool. In embodiments, the tool head is made of steel, titanium, or even aluminum.

In embodiments, the face cutters and the peripheral cutters are formed on the cutter carrier, and the cutter carrier consists of a single piece.

This makes it possible to use a one-piece cutter carrier that is comparatively easy to manufacture: the base material for the cutter carrier is identical to the material that forms the cutter.

In embodiments, the face cutter and the peripheral cutter are each formed on cutting elements, and the cutting elements are fastened to the cutter carrier with a material bond.

This makes it possible to achieve longer service lives of the cutter carrier. Compared to known cutter carriers with individually interchangeable cutters, no adjustment of the cutters is required. The cutting elements, being permanently connected to the cutter carrier, can be ground when manufacturing a cutter carrier. At the end of their service life, the entire cutter carrier is replaced. The cutting elements can be made of PCD (polycrystalline diamond). Other materials include MKD (monocrystalline diamond), CVD-D (chemical vapor deposition-thick film), or CBN (cubic boron nitride).

In embodiments, the cutter carrier includes coolant grooves on an end face, in particular on a frontal end face, for guiding coolant towards the cutters, wherein the coolant grooves run from an inner side of the cutter carrier, as seen in the radial direction, to an outer side of the cutter carrier.

This makes it possible to supply coolant to the cutters despite the comparatively small thickness of the cutter carrier, which does not allow channels to be formed within the cutter carrier. Further, compared to channels within the cutter carrier, the formation of the coolant grooves is much easier since they are located on an outer surface of the cutter carrier.

In embodiments, the cutter carrier is formed as a flat, annular plate with coolant grooves formed thereon and fastening holes with screw head receptacles.

This permits simple manufacturing of the cutter carrier from a plate-shaped blank.

In embodiments, the cutter carrier has a thickness in the axial direction of at most ten mm, in particular at most six mm, in particular at most five mm.

In embodiments, the cutting elements protrude in the axial direction by less than three mm, in particular less than two mm, in particular less than one and a half mm in front of the cutter carrier.

### BRIEF DESCRIPTION OF THE DRAWINGS

In the following, the subject matter of the invention will be explained in more detail on the basis of preferred embodiment examples, which are shown in the accompanying drawings. They show schematically in each case:

FIG. 1-3 a cutter carrier in a top view, a cross section and a perspective view;

FIG. 4-8 a tool head in various views and sections;

FIG. 9-15 a milling tool and its parts according to another embodiment; and

FIGS. 16-19 a coolant distribution plate in various views and exploded views.

### DETAILED DESCRIPTION OF THE INVENTION

In principle, parts which are identical or have the same effect are given the same reference signs in the figures.

In general, when an axial direction is mentioned, it refers to the axis of rotation about which the milling tool rotates during operation. The terms “radial”, “axial”, “circumferential” refer to this axis. The side of the milling tool facing a tool holder is referred to as the “rear side”, the opposite side as the “front side”.

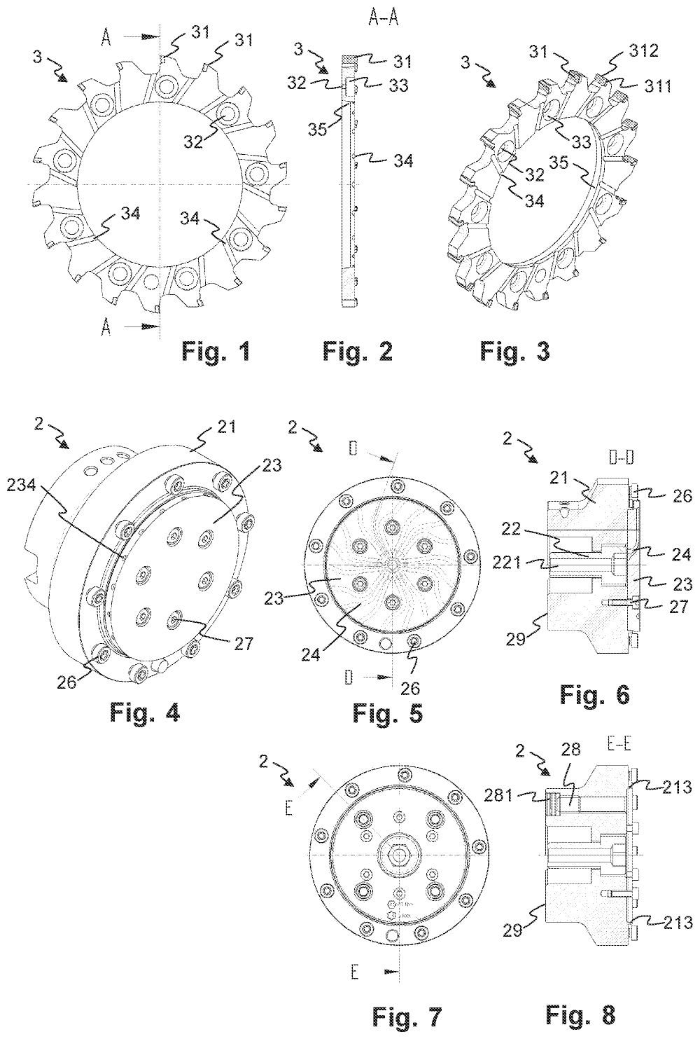

FIGS. 1-3 show a cutter carrier 3 in a top view, a cross section and a perspective view. The cutter carrier 3 is designed as an annular plate on which teeth with cutters are present along the circumference and chip spaces are formed between them. An inner cone 35 may be formed on an inner side of the ring, for precise centering of the cutter carrier 3 on a tool head 2. In other embodiments, a cylindrical connection is present instead of the inner cone 35. In the axial direction, the cutter carrier 3 is pierced by fastening holes 32. These each include screw head receptacles 33, into which interchangeable screws 26 can be countersunk for fastening the cutter carrier 3 to the tool head 2. A coolant groove 34 is assigned to each cutter or tooth, respectively, which guides coolant to the cutter. In the embodiments shown, the coolant grooves 34 are located on the front face of the cutter carrier 3, i.e. they face a workpiece being machined. Thus, although the coolant grooves 34 are open, channels are formed cooperating with the workpiece to guide the coolant to the cutters. This is possible because the intended use of milling tool 1 is face milling, and in so doing it is in close contact with the surface of the workpiece to be face milled.

The coolant grooves 34 are formed on the outer or front face of the cutter carrier 3. Each cutter can be assigned its own coolant groove 34.

In other embodiments, not shown, they are arranged on the rear face, thus. forming closed channels cooperating with the base body 21.

Cutters for machining the workpiece as face millers and, if necessary, also as peripheral millers are formed as face cutters 311 and as peripheral cutter 312. These cutters can be formed on the cutter carrier 3, i.e. by grinding the corresponding cutters (not shown). For this purpose, the cutter carrier 3 is formed of hard metal. The whole of the cutter carrier 3 and the cutters are thus formed in one piece. In the figures, on the other hand, it is shown that the face cutters 311 and peripheral cutters 312 are each formed on individual cutting elements 31. The cutting elements 31, in turn, are permanently connected to the cutter carrier 3, in particular by material bonding, for example by brazing or adhesive bonding. In both cases, the cutters are sharpened all together during manufacturing of the cutter carrier 3, and after wear, the cutter carrier 3 is replaced as a whole.

The cutting elements 31, if present, protrude in the axial direction by less than three, in particular less than two, in particular less than one and a half millimeters in front of the cutter carrier 3.

The cutting carrier 3 has a thickness in the axial direction of at most ten mm, in particular at most six mm, in particular at most five mm.

It is thus possible for the cutter carrier 3, including the cutters, with or without separate cutting elements 31, to have a thickness of at most ten mm, in particular at most six mm.

FIGS. 4-8 show a tool head 2 in various views and sections. The tool head 2 includes a base body 21 which can be coupled to a tool holder 4 at its rear side and is designed to receive the cutter carrier 3 at its front side.

For coupling to the tool holder 4, a mounting screw 22 is provided, wherein an orientation of the axis with respect to a machine spindle, to which the tool holder 4 is coupled, is adjustable by adjusting screws 28 via intermediate bodies 281. This is explained in connection with FIG. 14 below.

For mounting the cutter carrier 3 is screwed to the base body 21 by means of interchangeable screws 26, with the heads of the interchangeable screws 26 countersunk in the screw head receptacles 33. The cutter carrier 3 can include an inner cone 35 which is fitted onto an outer cone on a centering ring 213 of the base body 21. The centering ring 213 may be formed as a rib projecting in the axial direction from the base body 21, so that it can be compressed when the cutter carrier 3 is fitted.

A coolant distribution plate 23 is placed on the front end face of the base body 21 and fastened, for example, with plate screws 27. The coolant distribution plate 23 includes internal coolant channels 24 which are open in a central region of the coolant distribution plate 23 in the axial direction. Thus, they can be supplied with coolant through a longitudinal channel 221 of the mounting screw 22. The coolant channels 24 lead in the radial direction through the coolant distribution plate 23 to the cutter carrier 3. Thereby, a separate cooling channel 24 can be assigned to each cutter. The coolant channels 24 emerge from the coolant distribution plate 23 at its periphery. When the cutter carrier 3 is mounted, each coolant channel 24 leads into an associated coolant groove 34 of the cutter carrier 3. Typically, the two are aligned with each other, i.e., the coolant groove 34 forms a continuation of the coolant channel 24. The coolant channels 24 emerge from the coolant distribution plate 23 at outlet openings 234.

When replacing a cutter carrier 3, due to the interchangeability accuracy of the cutter carrier 3, the alignment of the tool head 2 with respect to the machine spindle (axial runout) does not need to be readjusted.

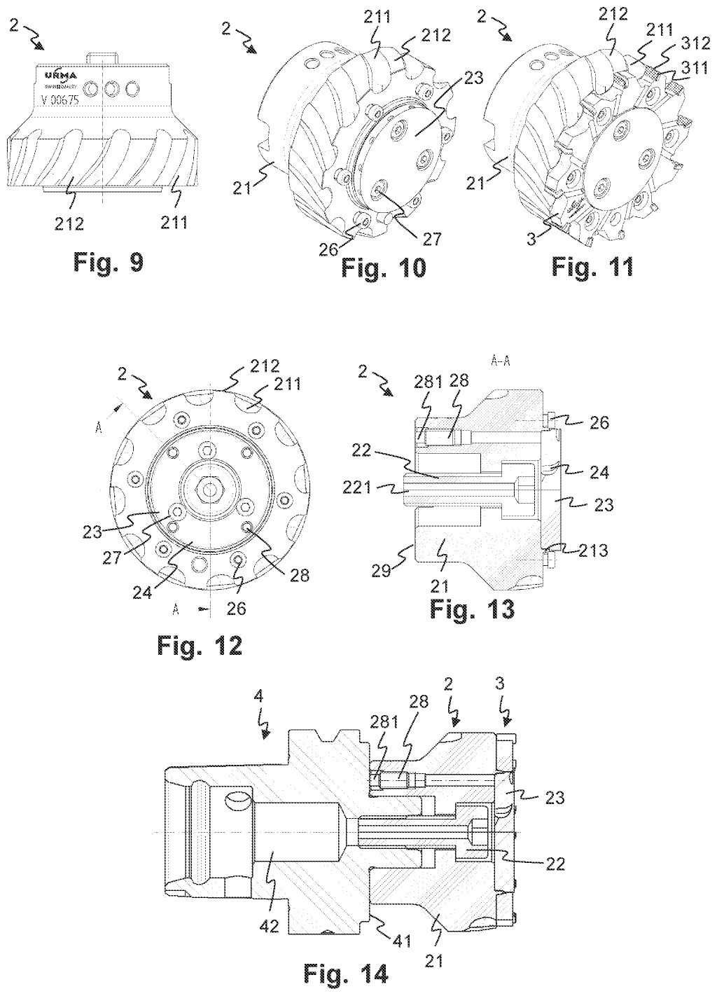

FIGS. 9-15 show a milling tool and its parts according to another embodiment. The elements shown and described so far are also present here, but with different proportions. In addition to these elements, the following can be seen in these figures:

At a front end of the base body 21, support sections 212 are present which are shaped to correspond to the circumferential contour of the cutter carrier 3, wherein in each case, a support section 212 supports a tooth of the cutter carrier 3 in the axial direction, i.e., absorbs machining forces in the axial direction. Between the support sections 212, pumping grooves 211 are formed in the form of indentations that extend backward in the axial direction from chip spaces between the cutters or teeth. They are helically curved with increasing pitch so that during operation of the milling tool 1 a pumping or suction effect is created, whereby cooling liquid with chips is conveyed to the rear.

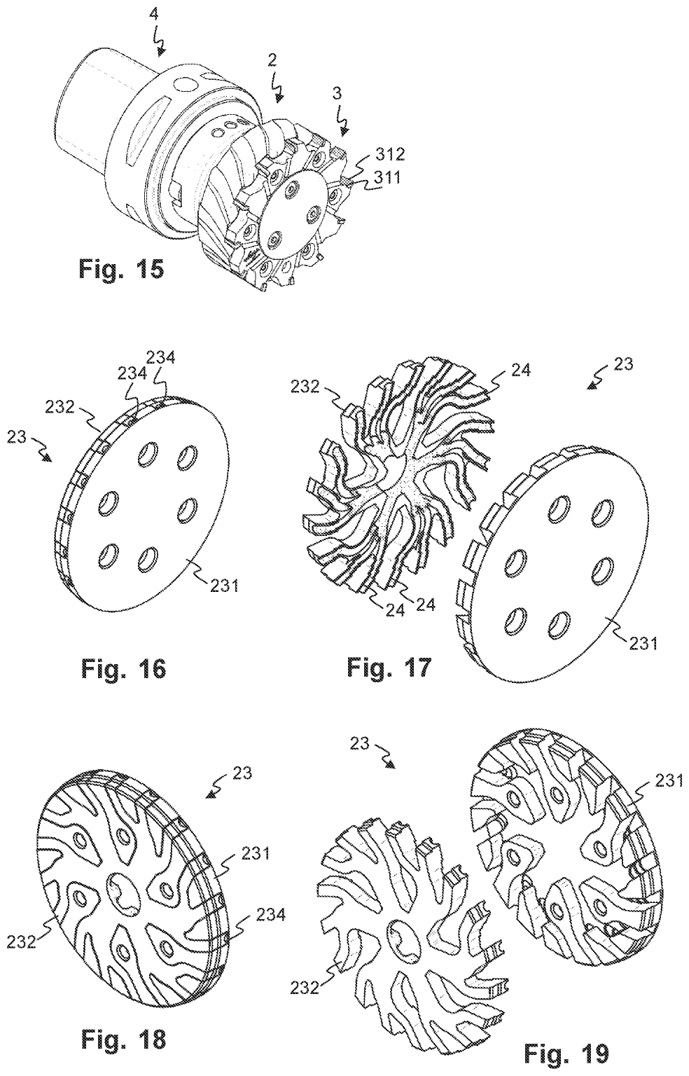

FIG. 10 shows a tool head 2 without cutter carrier 3, FIG. 11 with cutter carrier 3. FIGS. 14 and 15 show the milling tool 1 mounted on a tool holder 4, in a cross-sectional and perspective view. FIG. 14 shows how the tool head 2 is mounted on the tool holder 4 by means of the mounting screw 22. In the process, a rear side 29 of the tool head 2 and a contact surface 41 of the tool holder 4 are pressed against each other. The adjusting screws 28 distributed around the mounting screw 22 also press—via respective intermediate bodies 281—on the contact surface 41, thereby allowing the axis of the milling tool 1 to be aligned with respect to the axis of rotation of the one machine spindle to which the tool holder is attached. The adjusting screws 28 are countersunk in corresponding threaded holes in the base body 21, and can be adjusted from the front by means of an internal hexagon. For this purpose, the coolant distribution plate 23 is removed. FIG. 14 also shows a cavity 42 in the tool holder 4 for feeding coolant into the longitudinal channel 221 of the mounting screw 22.

FIGS. 16-19 show a multi-part construction of a coolant distribution plate 23. FIGS. 16 and 17 show the coolant distribution plate 23 in a view from the outside, FIGS. 18 and 19 from the inside, i.e. from the side of the base body 21. The coolant distribution plate 23 has an outer part or first part 231 and an inner part or second part 232, which are placed against each other, leaving spaces between the two parts, which form the coolant channels 24 with the outlet openings 234.

For this embodiment, as for those of the preceding figures, the coolant distribution plate 23 has the shape of a flat cylinder. The coolant channels 24 lead past through holes for the plate screws 27, so that the plate screws 27 do not come into contact with the coolant.

1. Milling tool with a tool head and an exchangeable cutter carrier, wherein the tool head is configured to be coupled to a tool holder and the cutter carrier comprises a plurality of cutters distributed around its periphery, each cutter comprising a front facing face cutter and a peripheral cutter extending at an angle thereto,
wherein the cutter carrier, including the cutters, for a diameter of at least fifty mm has a thickness of at most ten mm, in particular at most six mm.

2. Milling tool according to claim 1, wherein the tool head comprises a coolant distribution plate on a frontal end face, and the coolant distribution plate comprising coolant channels in order to conduct coolant flowing in the axial direction in radial directions to the cutter carrier, in particular wherein the coolant channels are located internally in the coolant distribution plate.

3. Milling tool according to claim 1, wherein the tool head comprises a coolant distribution plate on a frontal end face, and the coolant distribution plate defines a coolant distribution space which guides coolant inflowing in an axial direction into radial directions through outlet openings to the cutter carrier.

4. Milling tool according to claim 2, wherein the cutter carrier comprises coolant grooves on an end face, for guiding coolant towards the cutters, wherein the coolant grooves run from an inner side of the cutter carrier, as seen in the radial direction, to an outer side of the cutter carrier,
and wherein outlet openings of the coolant channels of the coolant distribution plate are aligned with the coolant grooves,
and in particular wherein one or more of the following is the case:
side walls of the coolant grooves are aligned with side walls of the coolant passages and the outlet openings, and
side walls of the coolant channels and the outlet openings define a cross-sectional area, wherein this cross-sectional area is included in a cross-sectional area defined by the side walls of the coolant grooves.

5. Milling tool according to claim 4, wherein the cutter carrier comprises the coolant grooves on a frontal end face, thereby when in operation facing a workpiece being machined.

6. Milling tool according claim 1, comprising a central mounting screw for fastening the tool head to a tool holder, and at least three, in particular exactly four adjusting screws arranged around the mounting screw, for exerting in each case a force in a direction parallel to the axis of rotation of the milling tool, for adjusting an alignment of the axis of rotation.

7. Milling tool according to claim 1, comprising a centering ring formed on the base body and projecting in the axial direction for centering a cutter carrier placed on the base body.

8. Milling tool according to claim 6, with the centering ring being formed on a radial outer surface as an outer cone, and by the cutter carrier being formed on a corresponding inner surface as an inner cone.

9. Milling tool according to claim 8, comprising grooves which are arranged along a circumference of the basic body and, starting from chip spaces between the cutters or teeth of the cutter carrier, run backwards in the axial direction and, in the process, run in a helically curved manner, having a pitch which increases with increasing distance from the cutter carrier, and, in particular, an initial pitch of the grooves being between thirty and sixty degrees, in particular between forty and fifty degrees.

10. Cutter carrier for a milling tool according claim 1, wherein the cutter carrier comprises a plurality of cutters arranged distributed around its circumference, each having a front facing face cutter and a peripheral cutter extending at an angle thereto,
wherein the cutter carrier, including the cutters, at a diameter of at least fifty mm, has a thickness of at most ten mm, in particular at most six mm.

11. Cutter carrier according to claim 10, wherein the cutter carrier is made of hard metal, ceramic or mixed forms thereof.

12. Cutter carrier according to claim 11, wherein the face cutters and the peripheral cutters are formed on the cutter carrier, and the cutter carrier consists of a single piece.

13. Cutter carrier according to claim 11, wherein the face cutter and the peripheral cutter are each formed on cutting elements, and the cutting elements are attached to the cutter carrier with a material bond.

14. Cutter carrier according to claim 10, wherein the cutter carrier comprises coolant grooves on an end face, for guiding coolant towards the cutters, wherein the coolant grooves run from an inner side of the cutter carrier, as seen in the radial direction, to an outer side of the cutter carrier.

15. Cutter carrier according to claim 14, wherein the cutter carrier comprises the coolant grooves on a frontal end face, thereby when in operation facing a workpiece being machined.

16. Cutter carrier according to claim 14, wherein the cutter carrier is formed as a flat, annular plate with coolant grooves and fastening holes with screw head receptacles formed thereon.

17. Cutter carrier according to claim 15, wherein the cutter carrier is formed as a flat, annular plate with coolant grooves and fastening holes with screw head receptacles formed thereon.

18. Cutter carrier according to claim 10, wherein the cutter carrier, excluding the cutters, has a thickness in the axial direction of at most ten mm, in particular of at most six mm, in particular of at most five mm.

19. Cutter carrier according to claim 13, wherein the cutting elements protrude in the axial direction in front of the cutter carrier by less than three mm, in particular less than two mm, in particular less than one and a half mm.

20. Cutter carrier according to claim 10,
wherein the cutter carrier is made of hard metal, ceramic or mixed forms thereof, wherein it either is the case that the face cutters and the peripheral cutters are formed on the cutter carrier, and the cutter carrier consists of a single piece, or it is the case that the face cutter and the peripheral cutter are each formed on cutting elements, and the cutting elements are attached to the cutter carrier with a material bond,
wherein the cutter carrier comprises coolant grooves on a frontal end face, thereby when in operation facing a workpiece being machined, for guiding coolant towards the cutters, wherein the coolant grooves run from an inner side of the cutter carrier, as seen in the radial direction, to an outer side of the cutter carrier,
wherein the cutter carrier is formed as a flat, annular plate with the coolant grooves and fastening holes with screw head receptacles formed thereon.

21. Tool head for a milling tool according to claim 1, wherein the tool head is configured to be coupled to a tool holder,
wherein the tool head comprises a coolant distribution plate on a frontal end face, and the coolant distribution plate comprises coolant channels for conducting coolant flowing in an axial direction into radial directions out of the coolant distribution plate, in particular wherein the coolant channels are located internally in the coolant distribution plate,
or wherein the tool head comprises a coolant distribution plate on a frontal end face, and the coolant distribution plate defines a coolant distribution space which guides coolant flowing in the axial direction into radial directions through outlet openings out of the coolant distribution plate.
